(19) United States
(12) Patent Application Publication
(10) Pub. No.: US 2016/0255328 A1
(43) Pub. Date: Sep. 1, 2016

(54) MULTIVIEW 3D TELEPRESENCE

(71) Applicant: HEWLETT-PACKARD DEVELOPMENT COMPANY, L.P., Houston, TX (US)

(72) Inventors: David A. Fattal, Palo Alto, CA (US); Charles M. SANTORI, Palo Alto, CA (US); Raymond G. BEAUSOLEIL, Palo Alto, CA (US)

(21) Appl. No.: 14/761,996

(22) PCT Filed: Feb. 26, 2015
(86) PCT No.: PCT/US2013/027740

§ 371 Date: Jul. 20, 2015

(51) Int. Cl. H04N 13/02; G02B 5/18; G02B 27/22; H04N 5/225

(52) U.S. Cl. CPC H04N 13/0203; H04N 5/2258; H04N 13/0296; G02B 5/1842; G02B 27/2214

(57) ABSTRACT

A multiview 3D telepresence system is disclosed. The system includes an integral imaging capture system and a direct view display system. The integral imaging capture system has a microlens array and a plurality of image sensors to generate a plurality of input image views. The direct view display system has a directional backplane with a plurality of directional pixels to scatter a plurality of input planar lightbeams into a plurality of directional lightbeams. A shutter layer in the direct view display system receives the plurality of input image views from the integral imaging capture system and modulates the plurality of directional lightbeams to generate a plurality of output image views for display.

### CROSS-REFERENCE TO RELATED APPLICATIONS

This application is related to PCT Patent Application Serial No. PCT/US2012/035573 (Attorney Docket No. 82963238), entitled “Directional Pixel for Use in a Display Screen”, filed on Apr. 27, 2012, PCT Patent Application Serial No. PCT/US2012/040305 (Attorney Docket No. 83011348), entitled “Directional Backlight”, filed on May 31, 2012, PCT Patent Application Serial No. PCT/US2012/040607 (Attorney Docket No. 82963242), entitled “Directional Backlight with a Modulation Layer”, filed or) Jun. 1, 2012, PCT Patent Application Serial No. PCT/US2012/058026 (Attorney Docket No. 82963246), entitled “Directional Waveguide-Based Backlight with integrated Hybrid Lasers for Use in a Muitiview Display Screen”, filed on Sep. 28, 2012, and U.S. patent application Ser. No. 13/755,582 (Attorney Docket No. 83100644), entitled “Viewing-Angle Imaging”, filed on Jan. 31, 2013, and assigned to the assignee of the present application and incorporated by reference herein.

### BACKGROUND

Telepresence applications have been developed to allow users feel as if they are present in a given location when in fact they are located somewhere else. For example, telepresence videoconferencing enables users to conduct business meetings in real-time from multiple locations around the world. Telepresence surgery enables a surgeon in one location to perform robotic assisted surgery in a patient in another location, sometimes many miles away. Other telepresence applications include telepresence fashion design and fashion shows, telepresence education, telepresence military exercises, and telepresence deep sea exploration, among others.

Currently available telepresence applications typically include an imaging capture system and an imaging display system, interconnected by a network. The imaging capture system captures the images in one location and transmits them over the network to the imaging display system at another location. The images transmitted may be compressed and processed in order to satisfy the bandwidth constraints imposed by the network. The images may also suffer from imaging system constraints inherent to the capture and display systems used. These imaging system constraints limit the imaging views that can be captured and transmitted, as well as hinder one from truly feeling present in the scene since 3D information, depth information, resolution, and other imaging features are lost in the capture/transmission/display process.

### BRIEF DESCRIPTION OF THE DRAWINGS

The present application may be more fully appreciated in connection with the following detailed description takes in conjunction with, the accompanying drawings, in which like reference characters refer to like parts throughout, and in which:

FIG. 1 illustrates a schematic diagram of a telepresence surgery application using the multiview 3D telepresence system according to various examples;

FIG. 2 illustrates a schematic diagram of a telepresence space exploration application, using the multiview 3D telepresence system according to various examples;

FIG. 3 illustrates a schematic diagram of a telepresence real estate application using the multiview 3D telepresence system according to various examples;

FIG. 4 illustrates an integral imaging capture system, in accordance with various examples;

FIG. 5 illustrates another example of an integral imaging capture-system;

FIG. 6 illustrates another example of an integral imaging capture system;

FIG. 7 illustrates a schematic diagram of a direct view display system in accordance with various examples;

FIGS. 8A-B illustrate top views of a directional backplane according to FIG. 7;

FIG. 9 illustrates an example directional, backplane of FIG. 7 having a triangular shape;

FIG. 10 illustrates an example directional backplane of FIG. 7 having an hexagonal shape;

FIG. 11 illustrates an example directional backplane of FIG. 7 having a circular shape;

FIG. 12 is a schematic diagram showing a multiview 3D telepresence system in accordance with various examples; and

FIG. 13 is a flowchart for providing a multiview 3D telepresence experience in accordance with the present application.

### DETAILED DESCRIPTION

A multiview 3D telepresence system is disclosed. The multiview 3D telepresence system is capable of offering users a full parallax, 3D, real-time telepresence experience by having images captured in one location with an integral imaging capture system and displayed at another location with a direct view display system. The direct view display system is able to display images that substantially match or reproduce the images captured by the integral imaging capture system. In various examples, the images captured by the integral imaging capture system may be transmitted to the direct view display system without any compression or interpolation.

The integral imaging capture system has a microlens array in front of multiple image sensors (e.g., CCD, CMOS, etc.) to capture multiple image views. The multiple image views are transmitted over a high speed, high capacity network link to the direct view display system, where they are displayed. The direct view display system has a unique directional backplane with multiple directional pixels and a shutter layer that are able to substantially reproduce the image views captured by the integral imaging capture system. This enables a user at the display location to feel present at the capture location with his/her own set of eyes, without any loss in reproduction of the captured images. That is, the user at a display location, has a full, parallax, 3D, and real-time telepresence experience.

In various examples, the direct view display system has a directional backplane that is used to provide a light field in the form, of directional ligbtbeams. The directional lightbeams are scattered by a plurality of directional pixels in the directional backplane. Each directional lightbeam originates from a different, directional pixel and has a given direction and angular spread based on characteristics of the directional pixel. This pointed directionality enables directional beams to be modulated (i.e., turned on, off or changed in brightness) and generate image views that substantially match or reproduce the image views that are captured by the integral imaging capture, system.

The directional pixels are arranged in a directional backplane that is illuminated by a plurality of input planar lightbeams. The directional pixels receive the input planar ligbtbeams and scatter a fraction of them into directional lightbeams. A shutter layer is placed above the directional pixels to modulate the directional lightbeams as desired. The shutter layer may include a plurality of modulators with active matrix addressing (e.g., Liquid Crystal Display (“LCD”) cells, MEMS, fluidic, magnetic, electrophoretic, etc.), with each modulator modulating a single directional lightbeam from a single directional pixel or a set of directional lightbeams from a set of directional pixels. The shutter layer enables image views to be generated that substantially match or reproduce the image views that are captured by the integral imaging capture system, with each view provided by a set of directional lightbeams.

In various examples, the directional pixels in the directional backplane have patterned gratings of substantially parallel grooves arranged in or on top of the directional backplane. The directional backplane may be, for example, a slab of transparent material that guides the input planar lightbeams into the directional pixels, such as, for example, Silicon Nitride (“SiN”), glass or quartz, plastic, Indium Tin Oxide (“ITO”), among others. The patterned gratings can consist of grooves etched directly in or made of material deposited on top of the directional backplane (e.g., any material that can be deposited and etched, or lift-off, including any dielectrics or metal). The grooves may also be slanted.

As described in more detail herein below, each directional pixel may be specified by a grating length (i.e., dimension along the propagation axis of the input planar lightbeams), a grating width (i.e., dimension across the propagation axis of the input planar lightbeams), a groove orientation, a pitch, and a duty cycle. Each directional pixel may emit a directional lightbeam with a direction that is determined by the groove orientation and the grating pitch and with an angular spread that is determined by the grating length and width. By using a duty cycle of or around 50%, the second Fourier coefficient of the patterned gratings vanishes thereby preventing the scattering of light in additional unwanted directions. This insures that only one directional lightbeam emerges from each directional pixel regardless of its output angle.

As further described in more detail herein below, a directional backplane can be designed with directional pixels that have a certain grating length, a grating width, a groove orientation, a pitch and a duty cycle that are selected to produce a given image view. The image view is generated from the directional lightbeams emitted by the directional pixels and modulated by the shutter layer according to the images captured by the integral imaging capture system.

It is appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

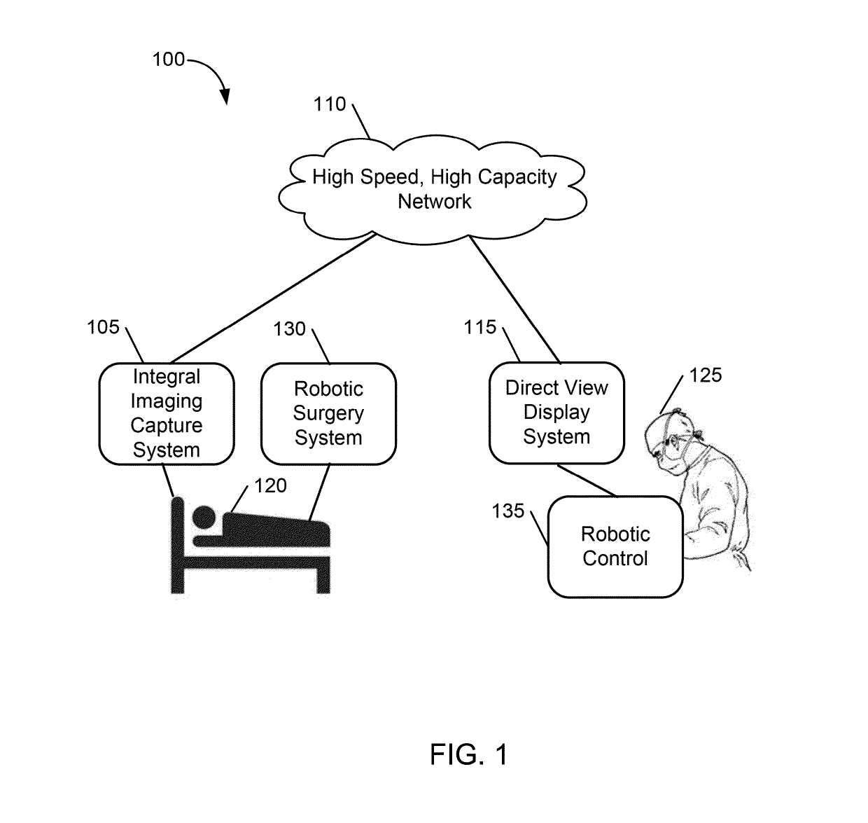

Referring now to FIG. 1, a schematic diagram of a telepresence surgery application using the muitiview 3D telepresence system according to various examples is described. Telepresence surgery application 100 has an integral imaging capture system 105 via a high speed, high capacity network 110 to a direct view display system 115. In this example, integral imaging capture system 105 is used to capture multiple views of a patient 120 during surgery in one location. The image views captured by integral imaging capture system 105 are transmitted via network 110 to direct view display system 115 in another location. A surgeon 125 views the images displayed by the direct view display system 115 and controls a robotic surgery system 130 at the patient's 120 location via a robotic surgery controller 135 at the surgeon's location. The image views captured by the integral imaging capture system 105 may be transmitted to the direct view display system 115 any compression, or interpolation.

The direct view display system 115 has a unique design (described in more detail herein below) with directional pixels that enables images to be displayed in the direct view display system 115 that substantially match or reproduce the angular characteristics of the captured images. That is, a one-to-one mapping (or at least a substantially one-to-one mapping) can be established between a pixel of the integral imaging capture system 105 and a directional pixel of the direct view display system 115. As a result of this one-to-one mapping, the surgeon 125 can perform a robotic controlled operation on a patient 120 from a location many miles away. With the use of the direct view display system 115 connected to the integral imaging capture system 105, the surgeon is able to have a full parallax, 3D, real-time view of the patient 120 and perform a surgery as if the surgeon were present in the same room as the patient 120. The surgeon 125 views the captured images in the direct view display system 115 without any toss in resolution, image quality, and other image characteristics. In various examples, the reproduced images may be displayed at a different scale than the captured images. This may be the case where images are captured in one scale (e.g., microscopic) and displayed at another scale (e.g., foil scale or zoomed in).

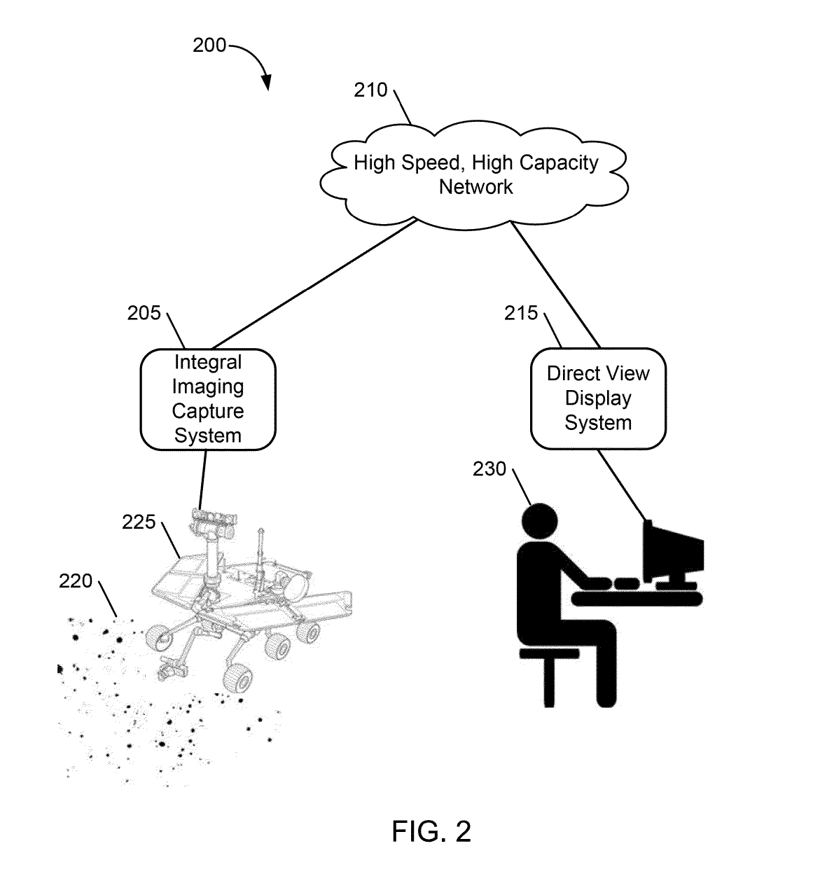

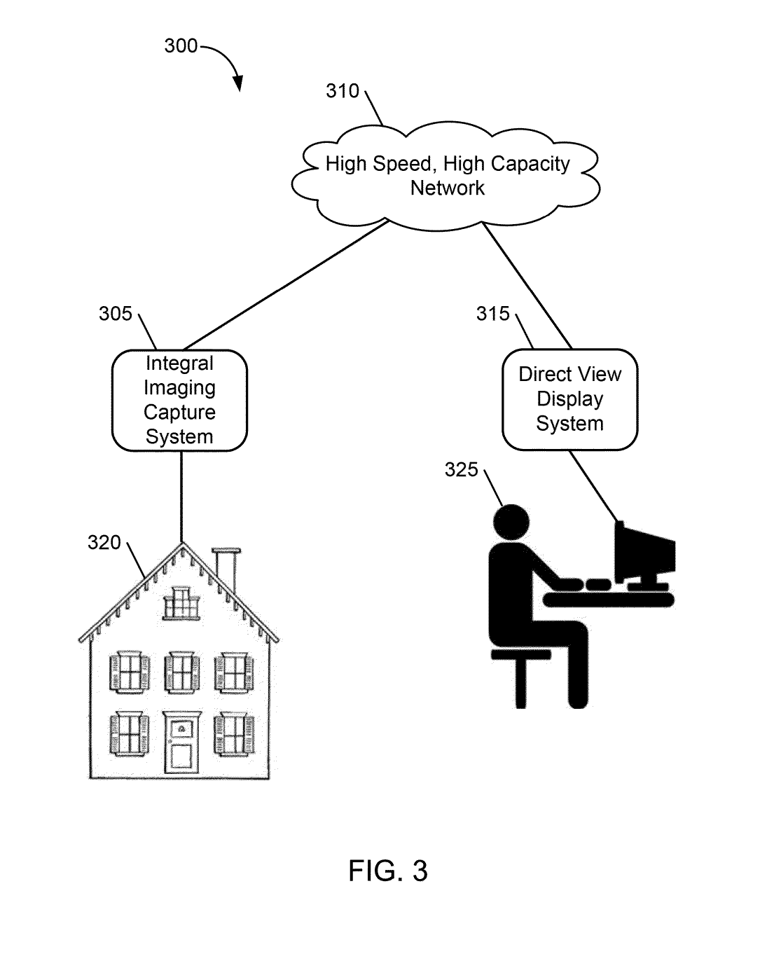

Attention is now directed to FIG. 2, which illustrates a schematic diagram of a telepresence space exploration application using the multiview 3D telepresence system according to various examples. Telepresence space exploration application 200 has an integral imaging capture system 205 connected via a high speed, high capacity network 210 to a direct view display system 215. In this example, integral imaging capture system 205 is used to capture multiple views of a surface 220 in space (e.g., a surface in Mars) with a rover 225. The image views captured by integral imaging capture system 205 are transmitted via network 210 to the direct view display system 215 in another location. A researcher 230 the images displayed by the direct view display system 215 in another location as if he/she were present at surface 220. The image views captured by the integral imaging capture system 205 may be transmitted to the direct view display system 215 without any compression or interpolation so that the researcher 230 is able to have a full parallax, 3D, real-time view of the surface 220. The researcher 230 views the captured images in the direct view display system 215 without any loss in resolution, image quality, and other image characteristics.

Another example of where the multiview 3D telepresence system described herein may be used in a telepresence application is shows in FIG. 3. In this case, an integral imaging capture system 305 is used to capture images of a real estate property 320 for sale. The captured images can be displayed at direct view display system 315 so that a potential buyer 325 can have a full parallax, 3D, and if desired, real-time, view of the real estate property 320. The potential buyer 325 views the captured images in the direct view display system 315 without any loss in resolution, image quality and other image characteristics.

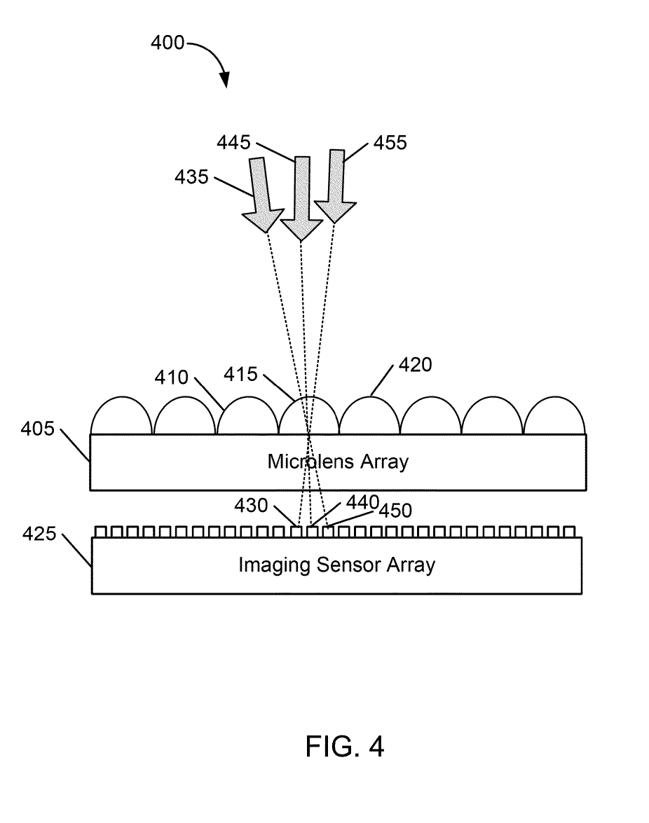

Referring now to FIG. 4, an integral imaging capture system in accordance with various examples is described. Integral imaging capture system 400 has a microlens array 405 with multiple microlenses, e.g., microlenses 410-420, to effectively capture a light field (i.e., a set of all light rays traveling in every direction through every point in space). The light field captured by the microlens array 405 is converted into electrical signals by the imaging sensor array 425, which has a plurality of image sensors (e.g., CCD, CMOS, etc.).

For a distant object being captured, each microlens in the microlens array 405 can take a different image view of the object. Each image sensor in the image sensor array 425 positioned below the microlens corresponds to a different position within the object. That is, each microlens is forming its own image of the object, as seen from a slightly different angle. For a very close object, each microlens in the microlens array 405 sees a different part of the object. The image sensors in the image sensor array 425 beneath the microlens capture a different image view of the object. It is appreciated that light rays coming in through a given microlens are detected by image sensors positioned directly below that microlens. For example, image sensor 450 may be used for light ray 435 captured, by microlens 415, image sensor 440 may be used for light ray 445 captured by microlens 415, and image sensor 430 may be used for light ray 455 captured by microlens 415.

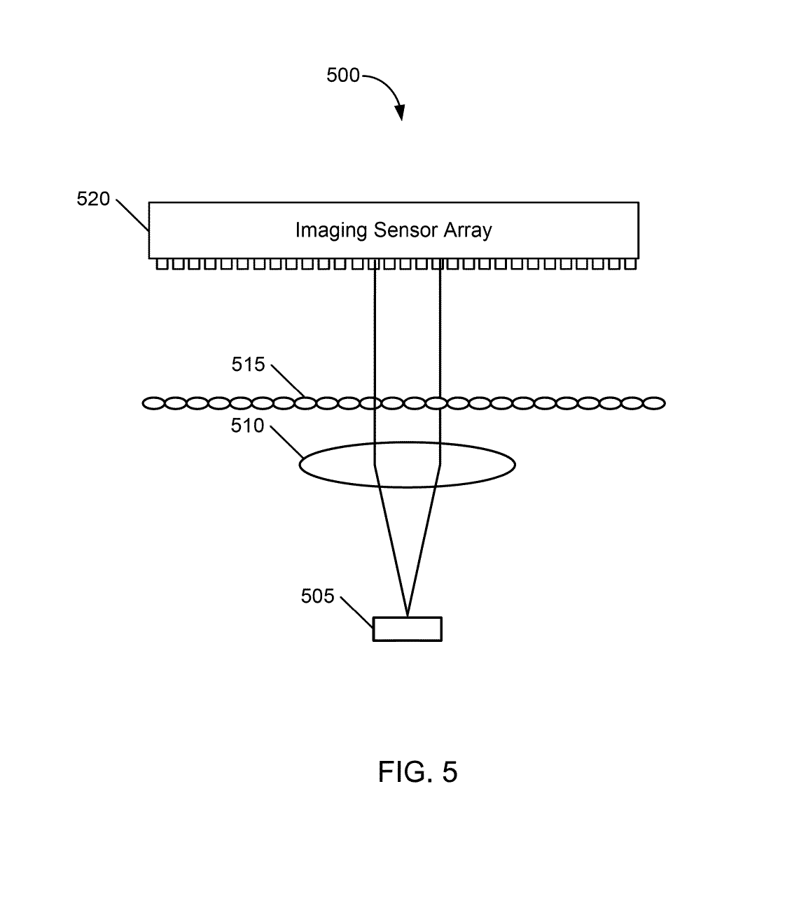

FIG. 5 shows another example of an Integral imaging capture system. Integral imaging capture system 500 may be used to capture images of a sample 505 in a microscopic or other such scale, e.g., a biology sample, a microscopic sample from a telepresence surgery application, and so on. A back light source (not shown) may be used behind the sample 505 to illuminate the sample 505 and form a light path going forward from the sample 505 to an imaging sensor array 520. Light from the sample 505 passes through an objective lens 510 positioned along the light path. In various examples, the objective lens 510 may be an infinity-corrected objective lens which generates a parallel light beam.

A microlens array 515 may be positioned at or near a Fourier plane (i.e., a focal plane of a converging microlens) relative to the sample 505. Further, the microlens array 515 may be positioned at a distance from the imaging sensor array 520 that is approximately equal to the focal length of the microlenses in the microlens array 515. Thus, a separate image generated from each microlens of the microlens array 515 may correspond to an image of the sample 505 for a different viewing angle. In various examples, the viewing angle of each separate image depends on the position of the corresponding microlens within the microlens array 515. It is appreciated that the separate images generated from each microlens of the microlens array 515 together generate a light field of the sample 505.

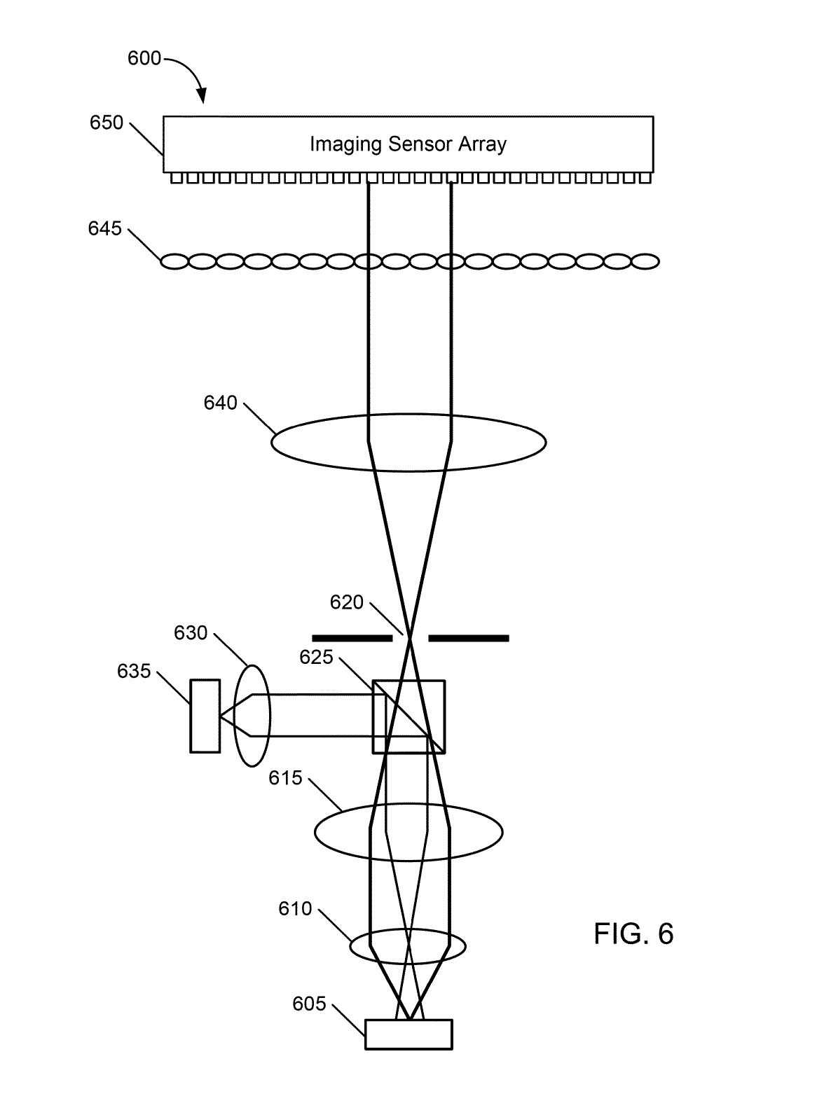

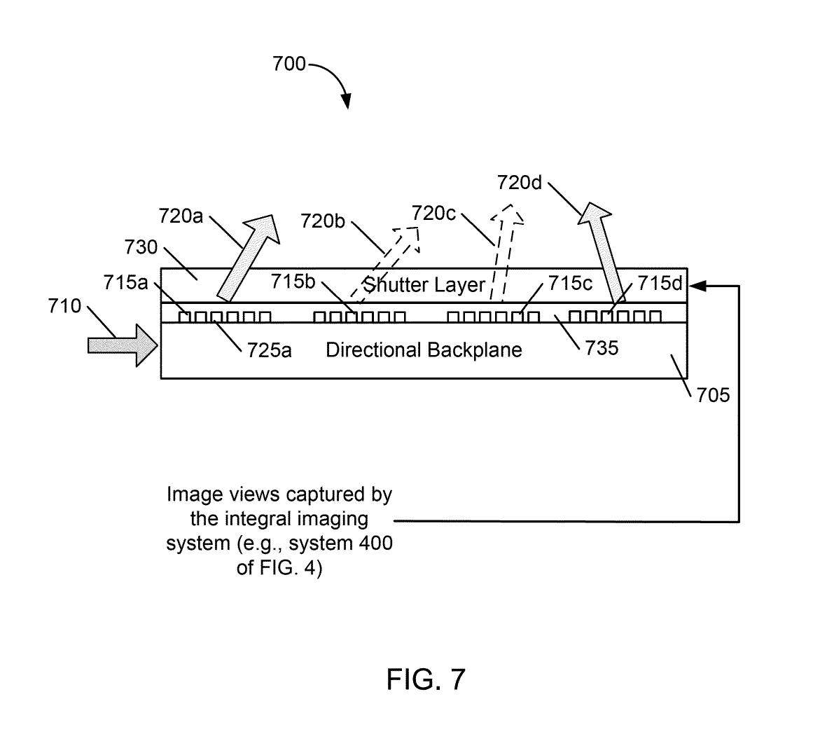

Another example of an integral imaging capture system is illustrated in FIG. 6. Integral imaging capture system 600 may be used to capture images of a sample 605 in a microscopic or other such scale. The integral imaging system 600 is configured to illuminate a sample 605 to be imaged with a light source 635. In various examples, the light source 635 include one or more light-emitting diodes (“LEDs”). In other examples, the light source 635 may include other types of suitable light sources. The light from the light source 635 is directed through, an illumination objective lens 630 to a reflector (or beamsplitter) 625. The illumination objective lens 630 may form substantially parallel light rays, which are reflected by the reflector 625 to the sample 605. Thus, the sample 605 may have reflective illumination.

Light from the sample 605 may be directed along a light path to a detector 650. In various examples, the detector 650 may be an imaging sensor array having a plurality of image sensors configured to form an image. In various examples, each image sensor of the imaging sensor array 650 corresponds to a pixel in the image. In various examples, the imaging sensor array 650 may be an array of charge-coupled de vices (“CCDs”) or an array of complementary metal-oxide semiconductor (“CMOS”) sensors. It is appreciated that various other types of detectors/sensors may be used in various examples.

Light from the sample 605 passes through an objective lens 610 positioned along the light path. In various examples, the objective lens 610 may be an infinity-corrected objective lens which generates a parallel light beam. The parallel light beam may be directed to an image-forming lens 615. In various examples, the image-forming lens 615 is positioned at approximately one focal length of the image-forming lens 615 from the back focal plane of the objective lens 610.

An aperture 620 may be positioned substantially at the image plane (e.g., approximately one focal length of the image-forming lens 615 from the image-forming lens 615). The aperture 620 may help define the field of view for the imaging sensor array 650. Light passing through the aperture 620 then passes through a re-collimating lens 640. In various examples, the re-collimating lens 640 is positioned at approximately one focal length of the re-collimating lens 640 from the aperture 620. The re-collimating lens 640 produces a substantially parallel light beam.

The combination of the image forming lens 615 and the re-collimating lens 640 allows for control over the magnification of the image of the sample 605 onto the imaging sensor array 650. This combination also allows the size of the beam to be matched to the size of the imaging sensor array 650. In various examples, the magnification may be 1.5×, 2× or any appropriate or desired magnification.

A microlens array 645 is positioned between the re-collimating lens 640 and the imaging sensor array 650. As noted below, in various examples, the microlens array 645 positioned substantially at a Fourier plane of the sample 605. Further, the microlens array 645 may be positioned at a distance from the imaging sensor array 650 that is approximately equal to the focal length of the microlenses in the microlens array 645. In various examples, the microlenses and the microlens array 645 may vary in size and shape, e.g., the microlens array 645 may include microlenses that have a pitch of 0.8 mm and a focal length of 7.5 mm.

In various examples, the microlens array 645 may be positioned substantially at a Fourier plane of the sample 605. In this regard, the microlens array 645 is positioned such that the distance between the re-collimating lens 640 and the microlens array 645 is approximately the local length of the re-collimating lens 640 (e.g., a Fourier plane of the sample 605 and the aperture 620). In various examples, positioning the microlens array 645 the Fourier plane (e.g., approximately one focal length from the re-collimating lens 640) produces certain desirable results. For example, in this configuration, different parts of the light beam correspond to different viewing angles of the sample 605. Further, the various sub-images corresponding to the different viewing angles are centered at substantially the same portion, of the sample 605.

It is appreciated that positioning the microlens array 645 at or near a Fourier plane of the sample 605 (or of the aperture 640) allows each microlens of the microlens array 645 to generate a separate image of the sample 605 onto the imaging sensor array 650. The separate image generated from each microlens of the microlens array 645 may correspond to an image of the sample for a different viewing angle. In various examples, the viewing angle of each separate image depends on the position, of the corresponding microlens within the microlens array 645. It is appreciated that the separate images generated, from each microlens of the microlens array 645 together generate a light field of the sample 605.

In one example, an objective lens 610 may be placed at a distance from the sample 605 of one focal length of the objective lens. The Fourier plane of the sample 605 occur one focal length of the objective lens 610 on the other side. For a compound lens system such as a microscope objective, the sample 605 is placed nearly at the front focal plane of the objective lens 610, while the distance from the sample 605 to the first surface of the objective lens 610 is approximately equal to the working distance of the objective lens 610. The first Fourier plane occurs at the back focal plane of the objective lens 610. Depending on the design of the objective lens 610, the back focal plane may occur either within or outside of the objective lens 610 assembly.

In one example, the image-forming lens 615 is placed so that its distance from the back focal plane of the objective lens 610 is approximately equal to the focal length of the image-forming lens 615. Similarly, another Fourier plane occurs relative to the image plane where the aperture 620 is positioned, in this regard, the re-collimating lens 640 may be positioned at a distance from the aperture 620 of approximately one focal length of the re-collimating lens 640. Thus, a Fourier plane of the sample 605 and the aperture 620 occurs on the other side of the re-collimating lens 640 at a distance of approximately one focal length of the re-collimating lens 640. In the example shown in FIG. 6, the microlens array 645 is positioned at this Fourier plane.

It is appreciated that integral imaging systems 400, 500, and 600, are examples of integral imaging systems that may be used to capture a light field. Other integral imaging systems may be designed and used herein with a direct view display system as described below.

Referring now to FIG. 7, a schematic diagram of a direct view display system in accordance with various examples is described. Direct view display system 700 includes a directional backplane 705 that receives a set of input planar lightbeams 710 from a plurality of light sources. The plurality of light sources may include, for example, one or more narrow-bandwidth light sources with a spectral bandwidth of approximately 30 nm or less, such as Light Emitting Diodes (“LEDs”), lasers (e.g., hybrid lasers), or any other light source used to provide illumination in a display system. The input planar lightbeams 710 in substantially the same plane as the directional backplane 705, which is designed to be substantially planar.

The directional backplane 705 may consist of a slab of a transparent material (e.g., SiN, glass or quartz, plastic, ITO, etc.) having a plurality of directional pixels 715a-d arranged in or on top of the directional backplane 705. The directional pixels 715a-d scatter a fraction of the input planar lightbeams 710 into directional lightbeams 720a-d. In various examples, each directional pixel 715a-d has patterned gratings of substantially parallel grooves, e.g., grooves 725a for directional pixel 715a. The thickness of the grating grooves can be substantially the same for all grooves resulting in a substantially planar design. The grooves can be etched in the directional backplane or be made of material deposited on top of the directional backplane 705 (e.g., any material that can be deposited and etched or lift-off, including any dielectrics or metal).

Each directional lightbeam 720a-d has a given direction and an angular spread that is determined by the patterned grating forming the corresponding directional pixel 715a-d. In particular, the direction of each directional lightbeam 720a-d is determined by the orientation and the grating pitch of the patterned gratings. The angular spread of each directional lightbeam is in turn determined by the grating length and width of the patterned gratings. For example, the direction of directional lightbeam 715a is determined by the orientation and the grating pitch, of patterned gratings 725a.

It is appreciated that this substantially planar design and the formation of directional lightbeams 720a-d from input planar lightbeams 710 requires gratings having a substantially smaller pitch than traditional diffraction gratings. For example, traditional diffraction gratings scatter light upon illumination with lightbeams that are propagating substantially across the plane of the grating. Here, the gratings in each directional pixel 715a-d are substantially on the same plane as the input planar lightbeams 710 when generating the directional lightbeams 720a-d.

The directional lightbeams 729a-d are precisely controlled by characteristics of the gratings in directional pixels 715a-d including a grating length L, a grating width W, a groove orientation θ, and a grating pitch Λ. In particular, the grating length L of grating 725a controls the angular spread ΔΘ of the directional lightbeam 720a along the input light propagation axis and the grating width W controls the angular spread ΔΘ of the directional lightbeam 720a across the input light propagation axis, as follows:

$$ΔΘ \approx \frac{4 λ}{π L} ( \frac{4 λ}{π W} ) \qquad ( Eq . 1 )$$

where λ is the wavelength of the directional lightbeam 720a. The groove orientation, specified by the grating orientation angle θ, and the grating pitch or period, specified by Λ, control the direction of the directional lightbeam 720a.

The grating length L and the grating width W can vary in size in the range of 0.1 to 200 μm. The groove orientation angle θ and the grating pitch Λ may be set to satisfy a desired direction of the directional lightbeam 720a, with, for example, the groove orientation angle θ on the order of −40 to +40 degrees and the grating pitch Λ on the order of 200-700 nm.

In various examples, a shutter layer 730 (e.g., LCD cells) is positioned above the directional pixels 715a-d to modulate the directional lightbeams 720a-d scattered by the directional pixels 715a-d. Modulation, of directional lightbeams 720a-d involves controlling their brightness with the shutter layer 730 (e.g., turning them on, off, or changing their brightness). For example, modulators in the shutter layer 730 may be used to turn on directional lightbeams 720a and 720d and turn off directional lightbeams 720b and 720c. The shutter layer 730 receives the image views captured by the integral imaging system (e.g., system 400, 500, or 600) and modulates the directional lightbeams generated by the directional backplane 705 to reproduce the captured image views. As noted above, the captured image views may be transmitted to the direct view display system 700 without any compression or interpolation.

In various examples, the shutter layer 730 may be placed on top of a spacer layer 735, which may be made of a material or simply consist of a spacing (i.e., air) between the directional pixels 715a-d and the shatter layer 730. The spacer layer 735 may have a width, for example, on the order of 0-100 μm.

It is appreciated that directional backplane 705 is shown with four directional pixels 715a-d for illustration purposes only. A directional backplane in accordance with various examples can be designed with many directional pixels (e.g., higher than 100). It is also appreciated that the directional pixels may have any shape, including for example, a circle, an ellipse, a polygon, or other geometrical shape.

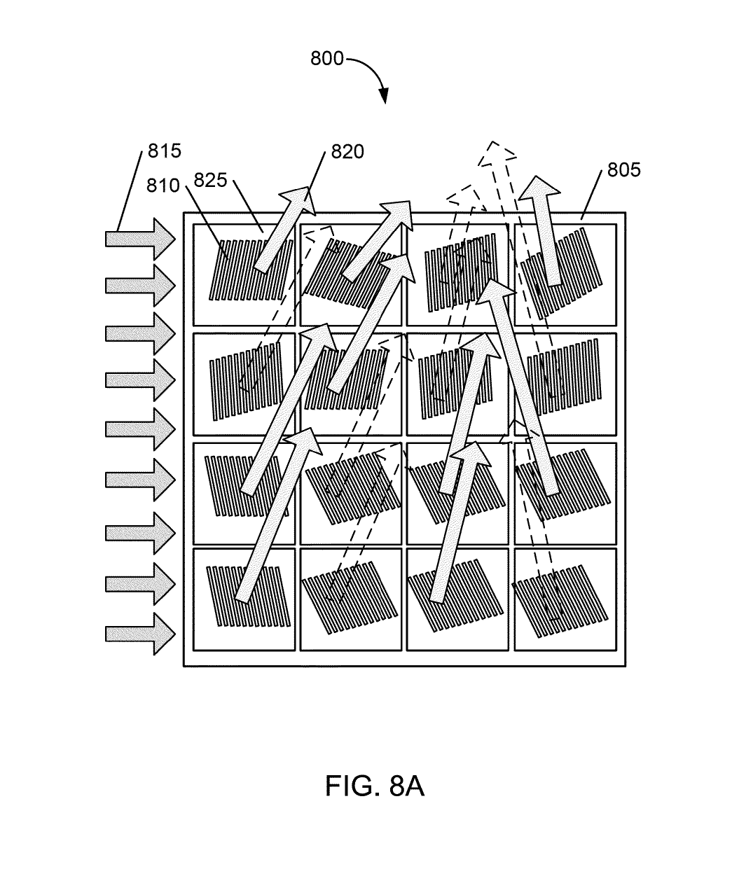

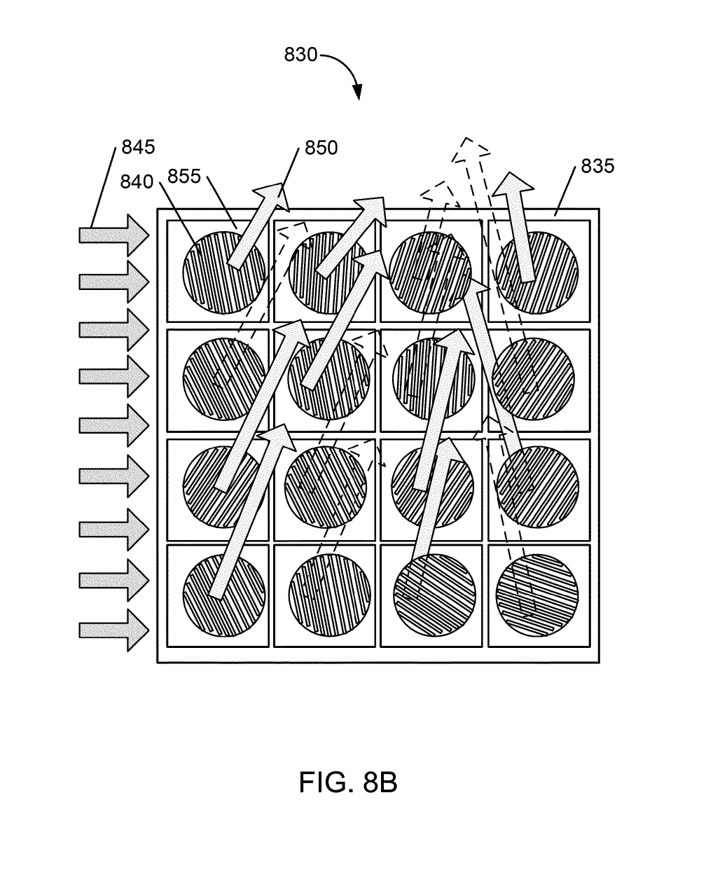

Attention is now directed to FIGS. 8A-B, which illustrate top views of a directional backplane according to FIG. 7. In FIG. 8A, direct view display system 800 is shown with a directional backplane 805 consisting of a plurality of polygonal directional pixels (e.g., directional pixel 810) arranged in a transparent slab. Each directional pixel is able to scatter a portion of the input planar lightbeams 815 into an output directional lightbeam (e.g., directional lightbeam 820). Each directional lightbeam is modulated by a modulator in a shutter layer (e.g., shutter layer 730 of FIG. 7), such as LCD cell 825 for directional lightbeam 820. The directional lightbeams scattered by all the directional, pixels in the directional backplane 805 and modulated by the shutter layer 830 reproduce the image views that, are captured by an integral imaging system (e.g., integral imaging system 400 of FIG. 4).

Similarly, in FIG. 8B, direct view display system 830 is shown with a directional backplane 835 consisting of a plurality of circular directional pixels (e.g., directional pixel 840) arranged in a transparent slab. Each directional pixel is able to scatter a portion of the input planar lightbeams 845 into an output directional, lightbeam (e.g., directional lightbeam 850). Each directional lightbeam is modulated by a modulator, e.g., LCD cell 855 for directional lightbeam 850. The directional lightbeams scattered by all the directional pixels in the directional backplane 835 and modulated by the modulators (e.g., LCD cell 855) reproduce the image views that are captured by an integral imaging system (e.g., integral imaging system 400 of FIG. 4).

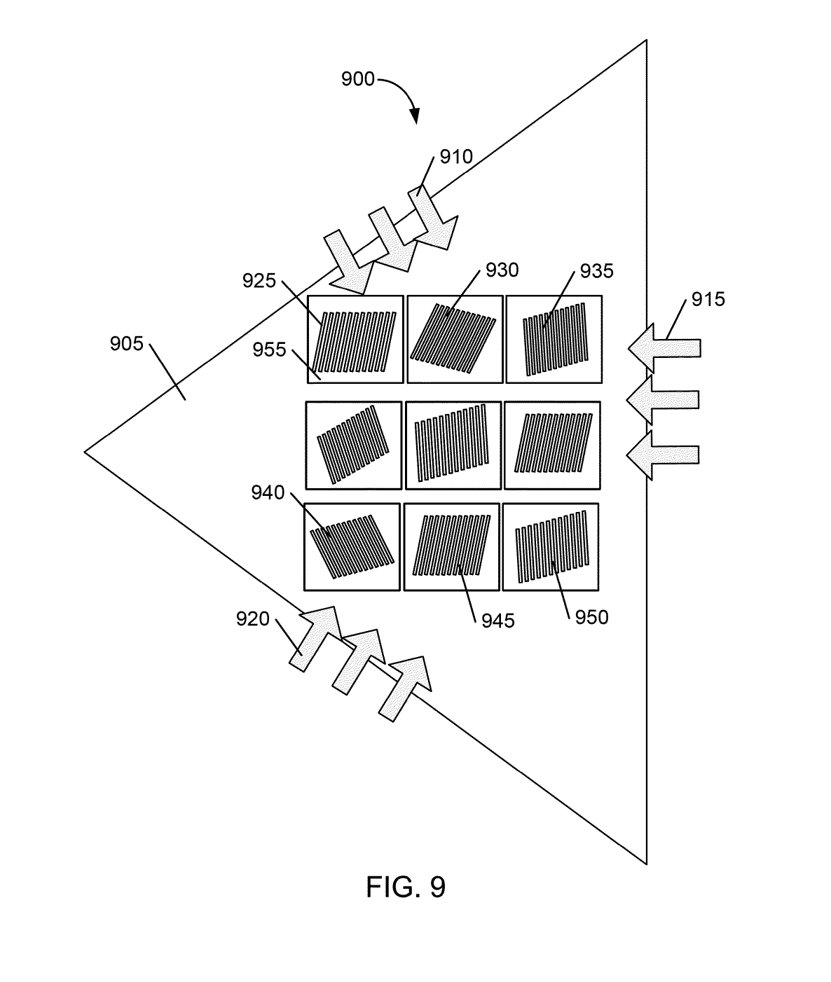

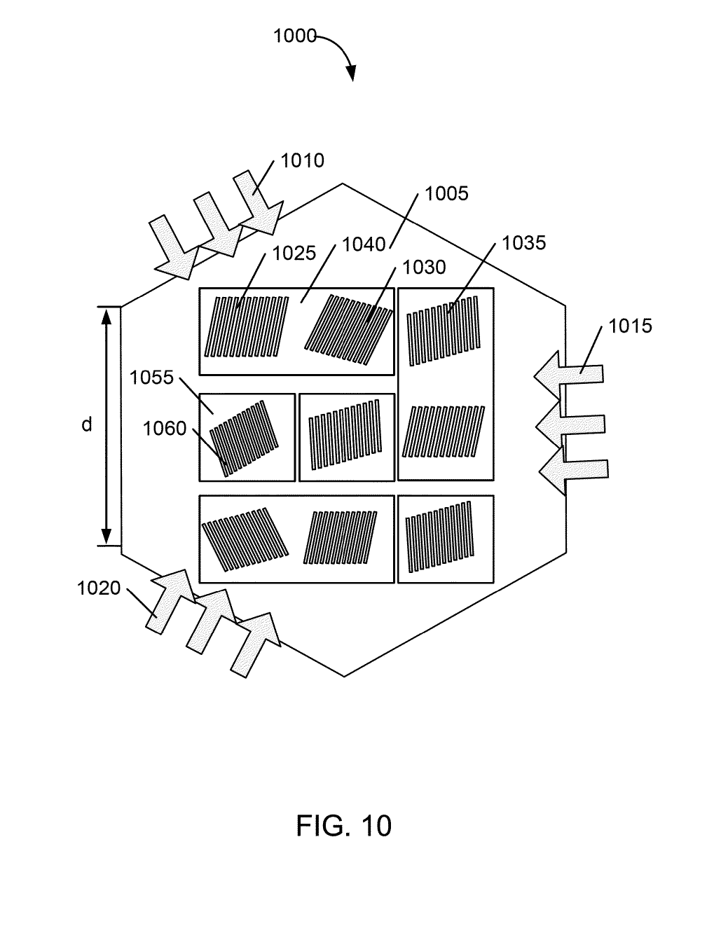

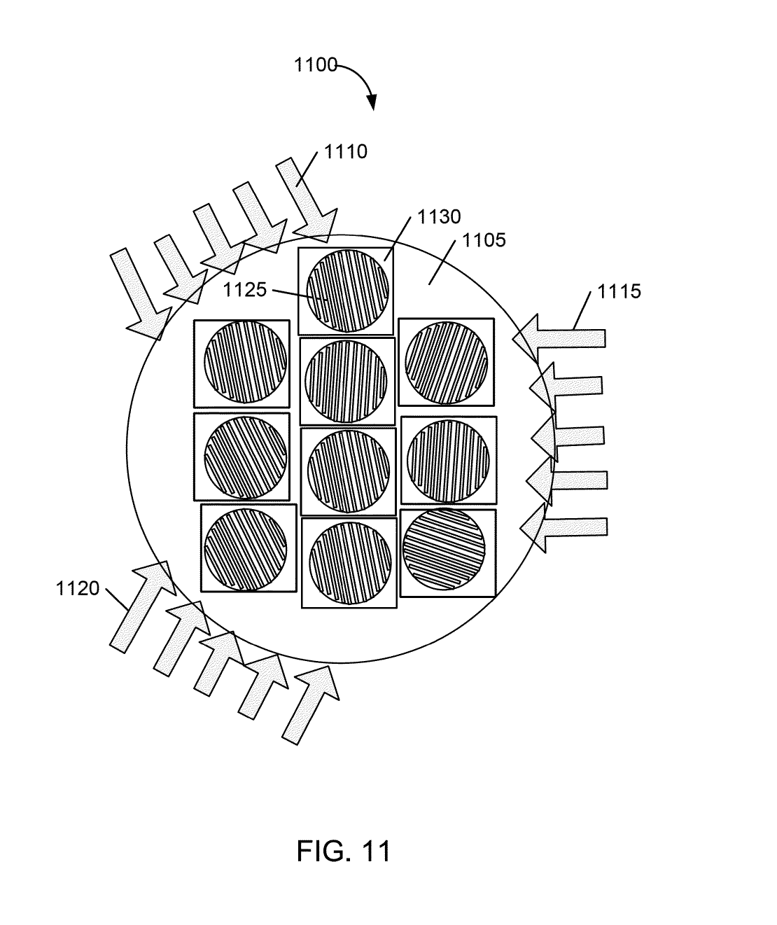

It is appreciated that a directional backplane in a direct view display system may be designed to have different shapes, such as, for example, a triangular shape (as shown in FIG. 9), a hexagonal shape (as shown in FIG. 10), or a circular shape (as shown in FIG. 11). In FIG. 9, the directional backplane 905 receives input planar lightbeams from three different spatial directions, e.g., input planar lightbeams 910-920. This configuration may be used when the input planar lightbeams represent light of different colors, e.g., with input planar lightbeams 910 representing a red color, input planar lightbeams 915 representing a green color, and input planar lightbeams 920 representing a blue color. Each of the input planar lightbeams 910-920 is disposed on a side of the triangular directional backplane 905 to focus their light on a set of directional pixels. For example, the input planar lightbeams 910 scattered into directional lightbeams by a set of directional pixels 925-935. This subset of directional, pixels 925-935 may also receive light from, the input planar lightbeams 915-920. However, by design this light is not scattered in the intended view zone of the direct view display system 900.

For example, suppose that input planar lightbeams 910 are scattered by a subset G_{A} of directional pixels 925-935 into an intended view zone. The intended view zone may be specified by a maximum ray angle θₘₐₓ measured from a normal to the directional backplane 905. Input planar lightbeams 910 may also be scattered by a subset of directional pixels G_{B} 940-950, however those unwanted rays are outside the intended view zone as long as:

$$sin {θ}_{max} \leq \frac{{λ}_{A} + {λ}_{B}}{{λ}_{A} {λ}_{B}} \sqrt{{( \frac{{n}_{eff}^{A}}{{λ}_{A}} )}^{2} + {( \frac{{n}_{eff}^{B}}{{λ}_{B}} )}^{2} - ( \frac{{n}_{eff}^{A}}{{λ}_{A}} ) ( \frac{{n}_{eff}^{B}}{{λ}_{B}} )} \qquad ( Eq . 2 )$$

where λ_{A} is the wavelength of input planar lightbeams 910, n_{eff}^{A} is the effective index of horizontal propagation of input planar lightbeams 910 in the directional backplane 905, λ_{B} is the wavelength of input planar lightbeams 920 (to be scattered by directional pixels 940-950), and n_{eff}^{B} is the effective index of horizontal propagation of input planar lightbeams 920 in the directional backplane 905. In case where the effective indices and wavelengths are substantially the same. Equation 2 reduces to:

$$sin {θ}_{max} \leq \frac{{n}_{eff}}{2} \qquad ( Eq . 3 )$$

For a directional backplane of refractive index n above 2 with input planar lightbeams propagating near the gracing angle, it is seen that the intended view zone of the display can be extended to the whole space (n_{eff}≧2 and sin θₘₐₓ˜1). For a directional backplane of lower index such as glass (e.g., n=1.46), the intended view zone is limited to about θₘₐₓ<arcsin(n/2) (±45° for glass).

It is appreciated that each directional lightbeam may be modulated by a modulator, such as, for example, LCD cell 955. Since precise directional and angular control of directional lightbeams can be achieved with each directional pixel in the directional backplane 905 and the directional lightbeams can be modulated by modulators such as LCD cells, the directional backplane 905 can be designed to generate many different views of 3D images.

It is further appreciated that the directional backplane 905 shown in FIG. 9 be shaped into a more compact design by realizing that the extremities of the triangular slab can be cut to form a hexagonal shape, as shown in FIG. 10. The directional backplane 1005 receives input planar lightbeams from three different spatial directions, e.g., input planar lightbeams 1010-1020. Each of the input planar lightbeams 1010-1020 is disposed on alternating sides of the hexagonal directional backplane 1005 to focus its light on a subset of directional pixels (e.g., directional pixels 1025-1035). In various examples, the hexagonal directional backplane 1005 has a side length that may range in the order of 10-30 mm, with a directional pixel size in the order of 10-30 μm.

It is appreciated that the directional backplane of a direct view display system can have any geometrical shape besides a triangular (FIG. 9) or hexagonal shape (FIG. 10) as long as light from three primary colors is brought from three different directions. For example, the directional backplane may be a polygon, a circle, an ellipse, or another shape able to receive light from three different directions. Referring now to FIG. 11, a directional backplane having a circular shape is described. Directional backplane 1105 in direct view display system 1100 receives input planar lightbeams 1110-1120 from three different directions. Bach directional pixel has a circular shape, e.g., directional pixel 1125, and scatters a directional lightbeam that is modulated by a modulator, e.g., LCD cell 1130. Each LCD cell has a rectangular shape and the circular directional backplane 1105 is designed to accommodate the rectangular LCD cells for the circular directional pixels (or for polygonal directional pixels if desired).

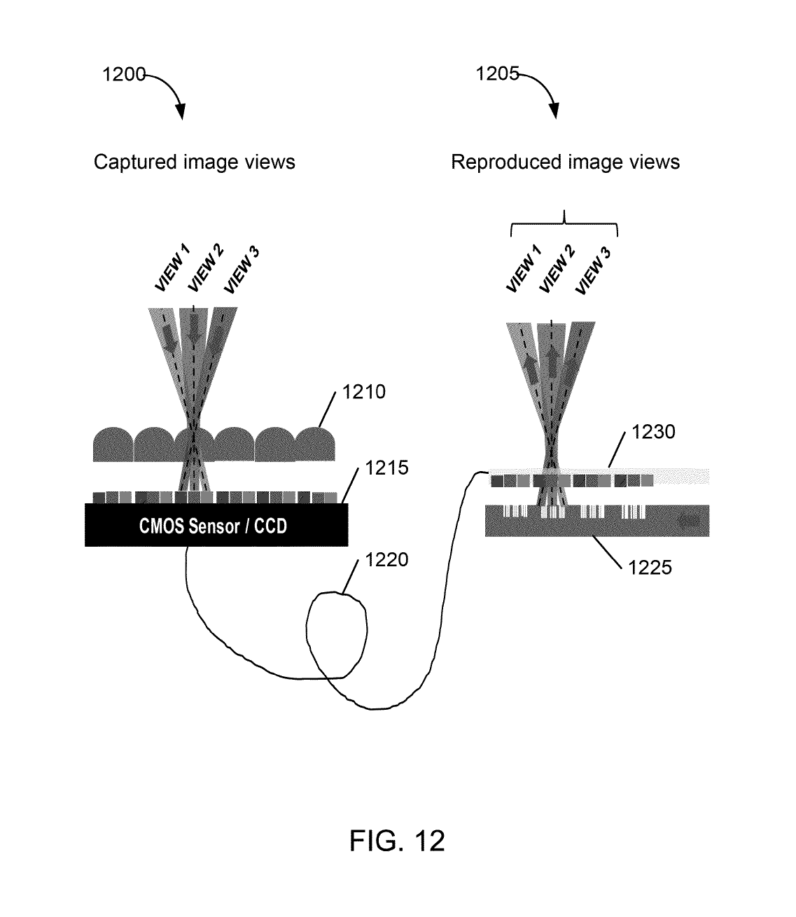

Referring now to FIG. 12, a schematic diagram, showing a muitiview 3D telepresence system in accordance with various examples is described. The telepresence system has an integral imaging capture system 1200 that is connected, to a direct view display system 1205 via a high speed, high capacity network link 1220. The network link 1220 may be a wired or a wireless link. The integral imaging capture system 1200 and the direct view display system 1205 may be co-located or located many miles away.

As described in more detail above, the integral imaging capture system 1200 has a microlens array 1210 and an array of microsensors 1215. The integral, imaging capture system 1200 captures 3D image views and transmits them over the network link 1220 to the direct view display system 1205. The image views may be transmitted without any compression or interpolation. The transmitted images are used to control a shutter layer 1230 the direct view display system 1205. The shutter layer 1230 modulates directional lightbeams that are generated by directional pixels in a directional backplane 1225. The directional pixels enable the direct view display system to substantially match or reproduce the captured image views. A viewer of the reproduced images is able to feel present at the image capture as if seeing the captured images with his/her own eyes, even though the viewer may be many miles away. The viewer is thus able to enjoy a full parallax, 3D, and real-time telepresence experience. In one example, the reproduced images may be displayed at a different scale than the captured images. This may be the case where images are captured in one scale (e.g., microscopic) and displayed at another scale (e.g., full scale or zoomed in).

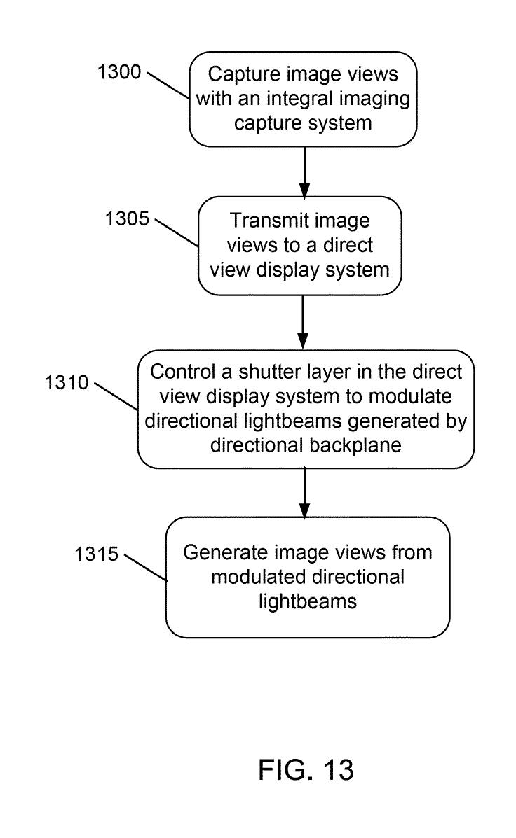

A flowchart for providing a muitiview 3D telepresence experience in accordance with the present application is illustrated in FIG. 13. An integral imaging capture system first captures a plurality of input image views (1300). The plurality of input image views are transmitted via a high speed, high capacity network link to a direct view display system (1305). The plurality of image views control a shutter layer at the direct view display system to modulate a plurality of directional lightbeams generated by a directional backplane in the direct view display system (1310). Lastly, a plurality of output image views are generated from modulated directional lightbeams (1315). The plurality of output image views substantially match or reproduce the plurality of input image views.

Advantageously, the multiview 3D telepresence system described herein enables a viewer to enjoy a full parallax, 3D, and real-time telepresence experience. The directional lightbeams generated by the directional, pixels in the direct view display system can be modulated to substantially match or reproduce image views that are captured by an integral imaging system.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the widest scope consistent with the principles and novel features disclosed, herein.

1. A multiview 3D telepresence system, comprising:
an integral imaging capture system having a microlens array and an imaging sensor array to generate a plurality of input image views; and
a direct view display system, comprising:
a directional backplane having a plurality of directional pixels to scatter a plurality of input planar lightbeams into a plurality of directional lightbeams, each directional lightbeam having a direction and angular spread controlled by characteristics of a directional pixel in the plurality of directional pixels; and
a shutter layer to receive the plurality of input image views from the integral imaging capture system and modulate the plurality of directional lightbeams to generate a plurality of output image views for display.

2. The multiview 3D telepresence system of claim 1, wherein the plurality of output image views substantially matches the plurality of input image views.

3. The multiview 3D telepresence system of claim 1, wherein the integral imaging capture system is connected to the direct view display system via a high speed, high capacity network.

4. The multiview 3D telepresence system of claim 1, wherein the direct view display system comprises a display screen to display the plurality of output image views m real-time.

5. The multiview 3D telepresence system of claim 1, wherein each directional pixel in the plurality of directional pixels comprises patterned gratings with a plurality of substantially parallel grooves.

6. The multiview 3D telepresence system of claim 5, wherein the characteristics of a directional pixel comprise a grating length, a grating width, a grating orientation, a grating pitch, and a duty cycle.

7. The multiview 3D telepresence system of claim 6, wherein the pitch and orientation of a directional pixel control the direction of a directional lightbeam scattered by the directional pixel.

8. The multiview 3D telepresence system of claim 6, wherein the length and width of a directional pixel control the angular spread of a directional lightbeam scattered by a directional pixel.

9. A method for providing a multiview 3D telepresence experience, comprising:
capturing a plurality of input image views with an integral imaging capture system;
transmitting the plurality of input image views via a network link to a direct view display system;
controlling a shutter layer at the direct view display system with the plurality of input image views to modulate a plurality of directional lightbeams generated by a directional backplane; and
generating a plurality of output image views from modulated directional lightbeams.

10. The method of claim 9, where in the plurality of output image views substantially matches the plurality of input image views.

11. The method of claim 9, wherein transmitting the plurality of input image views comprises transmitting a plurality of uncompressed input image views without any interpolation.

12. The method of claim 9, comprising displaying the plurality of output image views in real-time.

13. The method of claim 12, wherein the plurality of output image views is displayed at a different scale than the plurality of input image views.

14. A multiview 3D telepresence surgery system, comprising:
an integral imaging capture system having a microlens array and an imaging sensor array to generate a plurality of input image views of a patient during surgery at a first location; and
a direct view display system to assist a surgeon to perform the surgery on the patient from a second location, comprising:
a directional backplane having a plurality of directional pixels to scatter a plurality of input planar lightbeams into a plurality of directional lightbeams, each directional, lightbeam having a direction and angular spread controlled by characteristics of a directional pixel in the plurality of directional pixels; and
a shutter layer to receive the plurality of input image views from the integral imaging capture system and modulate the plurality of directional lightbeams to generate a plurality of output image views for display.

15. The multiview 3D telepresence surgery system of claim 14, wherein the plurality of output image views substantially matches the plurality of input image views.
